(19) United States
(12) Patent Application Publication
(10) Pub. No.: US 2018/0083789 A1
(43) Pub. Date: Mar. 22, 2018

(54) TRANSMISSION CIRCUIT, TRANSMISSION APPARATUS, AND METHOD FOR THE SAME

(71) Applicant: FUJITSU LIMITED, Kawasaki-si (JP)

(72) Inventor: Masaki Yamamoto, Yokohama (JP)

(73) Assignee: FUJITSU LIMITED, Kawasaki-si (JP)

(21) Appl. No.: 15/681,472

(22) Filed: Aug. 21, 2017

(30) Foreign Application Priority Data
Sep. 16, 2016 (JP) 2016-182205

(51) Int. Cl. H04L 9/34; H04L 9/12

(52) U.S. Cl. CPC H04L 9/34; H04L 2209/20; H04L 2209/125; H04L 9/12

(57) ABSTRACT

A transmission circuit includes: a transmission-side generation circuit configured to extract data at a predetermined byte position from user data to be transmitted, and to generate a transmission random pattern having a predetermined bit length by performing predetermined calculation processing using a value of the extracted data; a calculation circuit configured to generate transmission byte scrambled data by performing calculation on each byte of the user data and the generated transmission random pattern; a transmission-data coupling circuit configured to generate transmission scrambled data by coupling the generated transmission byte scrambled data and the data extracted by the transmission-side generation circuit; and a data-generation circuit configured to generate, from the transmission scrambled data, transmission data to be transmitted from the transmission circuit.

### CROSS-REFERENCE TO RELATED APPLICATION

This application is based upon and claims the benefit of priority of the prior Japanese Patent Application No. 2016-182205, filed on Sep. 16, 2016, the entire contents of which are incorporated herein by reference.

### FIELD

The embodiments discussed herein are related to a transmission circuit, a transmission apparatus, and a method for the same.

### BACKGROUND

It is known that scrambled data, which is generated by scrambling data using a given scrambling code, is transmitted. For instance, it is known that pieces of data scrambled with scrambling codes having different bit lengths are each transmitted in association with a synchronous word, and when the pieces of data are received, each piece of data is restored with a scrambling code corresponding to a relevant synchronous word (see, for example, Japanese Laid-open Patent Publication No. 61-225936). Also, it is known that in a reception device, one of scrambling codes used by a transmission device is identified from multiple types based on a correlation coefficient with reception data (see, for example, Japanese Laid-open Patent Publication No. 2014-192886).

However, the scrambled data generated by scrambling the same data using a given scrambling code has the same pattern. When the same pattern generated using a given scrambling code is transmitted, transmitted data has a specific frequency, and thus a reception error may occur in a reception circuit.

In an embodiment, a transmission circuit capable of removing bias in generated scrambled data is achieved.

### SUMMARY

According to an aspect of the embodiments, a transmission circuit includes: a transmission-side generation circuit configured to extract data at a predetermined byte position from user data to be transmitted, and to generate a transmission random pattern having a predetermined bit length by performing predetermined calculation processing using a value of the extracted data; a calculation circuit configured to generate transmission byte scrambled data by performing calculation on each byte of the user data and the generated transmission random pattern; a transmission-data coupling circuit configured to generate transmission scrambled data by coupling the generated transmission byte scrambled data and the data extracted by the transmission-side generation circuit; and a data-generation circuit configured to generate, from the transmission scrambled data, transmission data to be transmitted from the transmission circuit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example transmission system related;

FIGS. 2A to 2C are diagrams for illustrating the processing of user data performed by the transmission system illustrated in FIG. 1;

FIG. 3A is an internal circuit diagram of a diffusion circuit illustrated in FIG. 1, FIG. 3B is an internal circuit diagram of an inverse diffusion circuit illustrated in FIG. 1, and FIG. 3C is an internal circuit of an example PN pattern generation circuit illustrated in FIGS. 3A and 3B;

FIG. 4A is a flowchart illustrating the processing of the transmission device illustrated in FIG. 1, and FIG. 4B is a flowchart illustrating the processing of the reception device illustrated in FIG. 1;

FIG. 5 is a diagram for explaining a problem in the transmission system illustrated in FIG. 1;

FIG. 6 is a diagram illustrating a transmission system according to a first embodiment;

FIG. 7 is an internal circuit diagram of the diffusion circuit illustrated in FIG. 6;

FIG. 8 is an internal circuit diagram of the first byte extraction circuit illustrated in FIG. 7;

FIG. 9 is an internal circuit diagram of the PN pattern generation circuit illustrated in FIG. 7;

FIG. 10 is a diagram illustrating a connection relationship between the diffusion calculation circuit and the data coupling circuit illustrated in FIG. 6;

FIG. 11 is a flowchart illustrating the operation of the diffusion circuit illustrated in FIG. 6;

FIG. 12 is an internal circuit diagram of the inverse diffusion circuit illustrated in FIG. 6;

FIG. 13 is an internal circuit diagram of the first byte extraction circuit illustrated in FIG. 12;

FIG. 14 is a flowchart illustrating the operation of the inverse diffusion circuit illustrated in FIG. 6;

FIG. 15 is a diagram illustrating a transmission system according to a second embodiment;

FIG. 16 is an internal circuit diagram of the diffusion circuit illustrated in FIG. 15;

FIG. 17 is an internal circuit diagram of the initial value byte extraction circuit illustrated in FIG. 16;

FIG. 18 is a diagram illustrating a connection relationship between the diffusion calculation circuit, the data coupling circuit, the user data buffer circuit, and the extraction data insertion point counter illustrated in FIG. 15;

FIG. 19 is a flowchart illustrating the operation of the diffusion circuit illustrated in FIG. 15;

FIG. 20 is an internal circuit diagram of the inverse diffusion circuit illustrated in FIG. 15;

FIG. 21 is an internal circuit diagram of the initial value byte extraction circuit illustrated in FIG. 20;

FIG. 22 is a flowchart illustrating the operation of the inverse diffusion circuit illustrated in FIG. 15;

FIG. 23 is a diagram illustrating an example of generation of scrambled data in the transmission system illustrated in FIG. 6; and

FIG. 24 is a diagram illustrating a transmission system according to a third embodiment.

### DESCRIPTION OF EMBODIMENTS

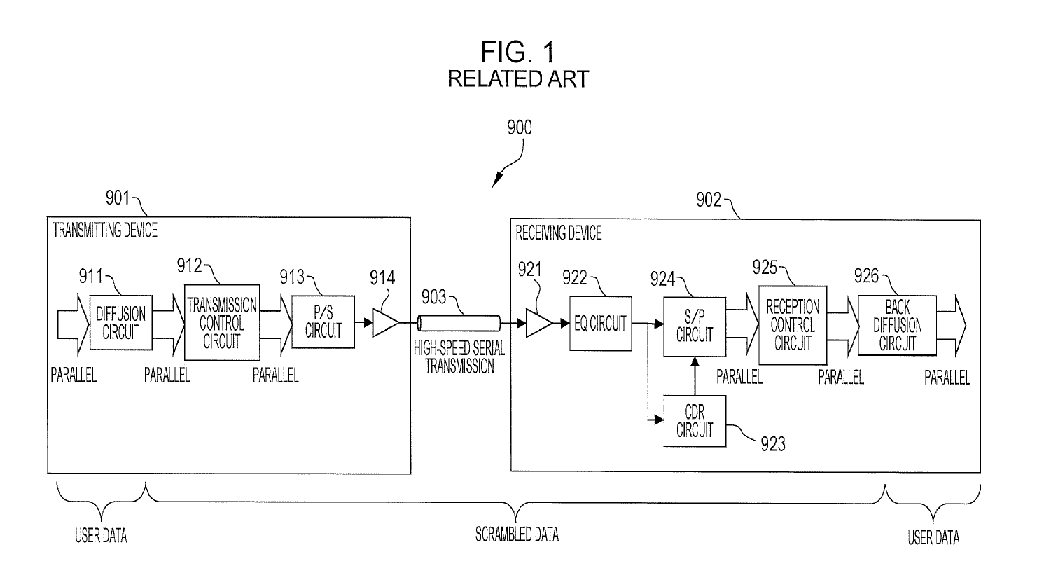

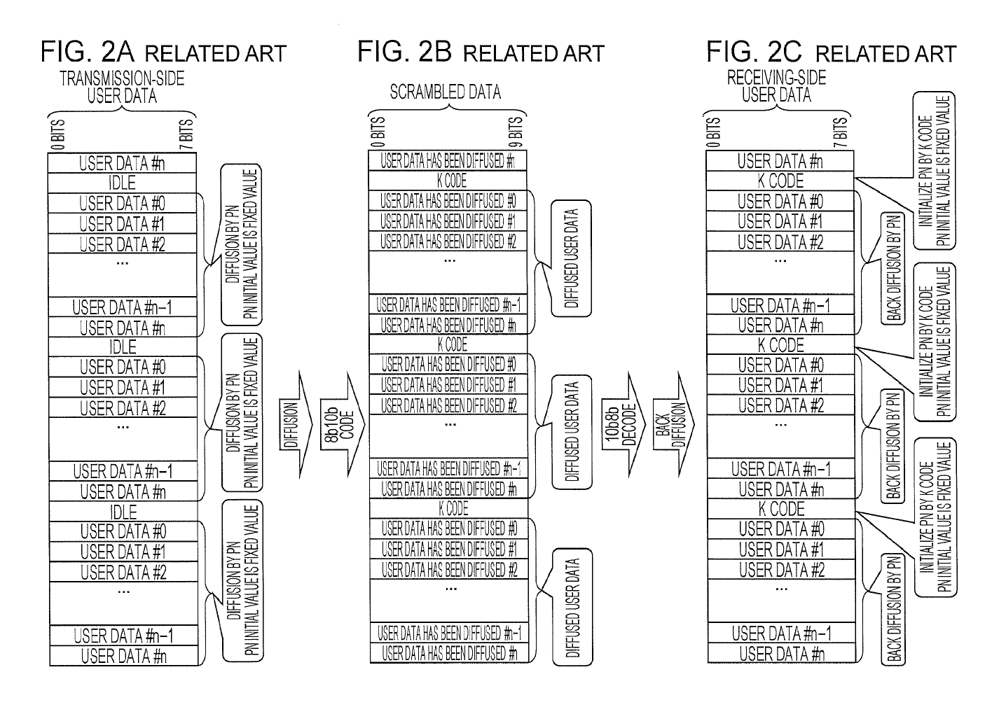

A related transmission system will be described before an embodiment is described. FIG. 1 is a diagram illustrating an example transmission system related, and FIGS. 2A and 2B are diagrams for illustrating the processing of user data performed by the transmission system illustrated in FIG. 1.

A transmission system 900 has a transmission device 901, a reception device 902, and an optical fiber 903 that is a transmission path between the transmission device 901 and the reception device 902.

The transmission device 901 has a diffusion circuit 911, a transmission control circuit 912, a parallel-serial conversion circuit 913, and an E/O conversion circuit 914. The transmission device 901 obtains user data illustrated in FIG. 2A. The user data is parallel data, and includes an idle byte located between multiple D codes #0 to #n having a byte length of (n+1) and other multiple D codes #0 to #n having a byte length of (n+1). In each of multiple D codes #0 to #n, a signal value corresponding to data generated by a calculation circuit is disposed, and K code, which is data for control, is inserted in each idle byte. After diffusing user data, the transmission device 901 converts data to 10-bit data for every 8 bits, and generates transmission data which is to be transmitted to the reception device 902 via the optical fiber 903. The transmission data to be transmitted to the reception device 902 is illustrated in FIG. 2B.

The diffusion circuit 911 performs predetermined calculation processing, and generates scrambled data by scrambling user data inputted from a calculation circuit. The transmission control circuit 912 performs protocol control of 8b/10b, and generates transmission data by synchronizing the scrambled data generated by the diffusion circuit 911. Specifically, the transmission control circuit 912 converts the user data to 10-bit data for every 8 bits, inserts K code, which is data for control, in each idle byte of the user data illustrated in FIG. 2A, and generates the transmission data illustrated in FIG. 2B.

The parallel-serial conversion circuit 913 converts the transmission data generated by the transmission control circuit 912 to serial data. The E/O conversion circuit 914 converts the transmission data, which has been converted to serial data by the transmission control circuit 912, to an optical signal, and transmits the transmission data converted into an optical signal to the reception device 902 as a transmission signal via the optical fiber 903. The parallel-serial conversion circuit 913 and the E/O conversion circuit 914 are each a transmission signal generation circuit that generates a transmission signal from the transmission data.

The reception device 902 has an O/E conversion circuit 921, an equalizer 922, a signal reproduction (clock data recovery (CDR)) circuit 923, a serial-parallel conversion circuit 924, a reception control circuit 925, and an inverse diffusion circuit 926. The reception device 902 converts the transmission data illustrated in FIG. 2B to 8-bit data for every 10 bits, then performs inverse diffusion to restore the user data illustrated in FIG. 2C.

The O/E conversion circuit 921 receives a transmission signal, as a reception signal, transmitted from the transmission device 901 as an optical signal via the optical fiber 903, and converts the reception signal to reception data which is an electrical signal. The equalizer 922 is also referred to as an equalizing device, and corrects the waveform of the signal that indicates the reception data converted to an electrical signal. The CDR circuit 923 reproduces a clock from the reception data with the signal waveform corrected by the equalizer 922. The serial-parallel conversion circuit 924 converts the reception data with the signal waveform corrected by the equalizer 922 to parallel data using the clock reproduced by the CDR circuit 923. The O/E conversion circuit 921, the equalizer 922, the CDR circuit 923, and the serial-parallel conversion circuit 924 are each a reception data generation circuit that generates reception data from the reception signal.

The reception control circuit 925 performs protocol control of 8b/10b, and restores the scrambled data from the reception data which has been converted to parallel data by the serial-parallel conversion circuit 924. The inverse diffusion circuit 926 performs inverse diffusion on the scrambled data restored by the reception control circuit 925, and restores the user data illustrated in FIG. 2C. When performing inverse diffusion on the scrambled data, the inverse diffusion circuit 926 synchronizes the scrambled data according to the K code.

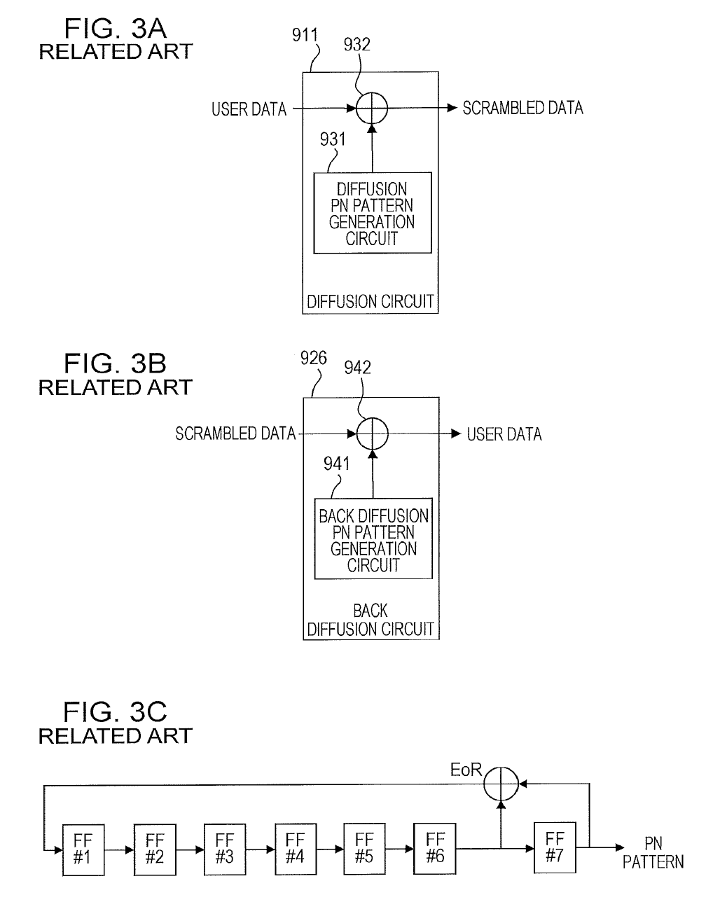

FIG. 3A is an internal circuit diagram of the diffusion circuit 911, FIG. 3B is an internal circuit diagram of the inverse diffusion circuit 926, and FIG. 3C is an internal circuit of an example PN pattern generation circuit illustrated in FIGS. 3A and 3B.

The diffusion circuit 911 has a diffusion PN pattern generation circuit 931 and a diffusion circuit 932. The diffusion PN pattern generation circuit 931 generates a random pattern, which is also referred to as a pseudo random noise (PN) pattern, from a generator polynomial such as PN7(X⁷+X⁶+1) or PN15(X¹⁵+X¹⁴+1) using a predetermined initial value also referred to as a seed value. When using PN7 as a generator polynomial, the diffusion PN pattern generation circuit 931 is formed of seven registers (FF) and an EOR circuit as illustrated in FIG. 3C. Before starting calculation, the diffusion PN pattern generation circuit 931 sets an initial value to each register, and generates a PN pattern by shifting data to be held by each register according to a clock.

The diffusion PN pattern generation circuit 931 initializes the PN pattern according to detection of an idle byte of the user data. The diffusion PN pattern generation circuit 931 generates a PN pattern using an initial value according to detection of an idle byte of the user data, thereby periodically generating a PN pattern corresponding to D codes #0 to #n included in the user data.

The diffusion circuit 932 generates scrambled data by calculating exclusive OR between the PN pattern generated by the diffusion PN pattern generation circuit 931 and user data inputted from a calculation circuit. The PN pattern has a period corresponding to D codes #0 to #n included in the user data.

The inverse diffusion circuit 926 has an inverse diffusion PN pattern generation circuit 941 and an inverse diffusion circuit 942. The inverse diffusion PN pattern generation circuit 941 initializes the PN pattern according to detection of K code in the scrambled data. Specifically, the inverse diffusion PN pattern generation circuit 941 generates a PN pattern using an initial value according to detection of K code in the scrambled data, thereby periodically generating a PN pattern corresponding to D codes #0 to #n. The initial value used by the inverse diffusion PN pattern generation circuit 941 to generate a PN pattern is the same as the initial value used by the diffusion PN pattern generation circuit 931.

The inverse diffusion circuit 942 restores the user data by calculating exclusive OR between the PN pattern generated by the inverse diffusion PN pattern generation circuit 941, and scrambled data having a period corresponding to D codes #0 to #n included in the synchronized user data. Similarly to the diffusion circuit 932, it is possible for the inverse diffusion circuit 942 to restore the user data transmitted by performing inverse diffusion using a PN pattern having a period corresponding to D codes #0 to #n included in the user data.

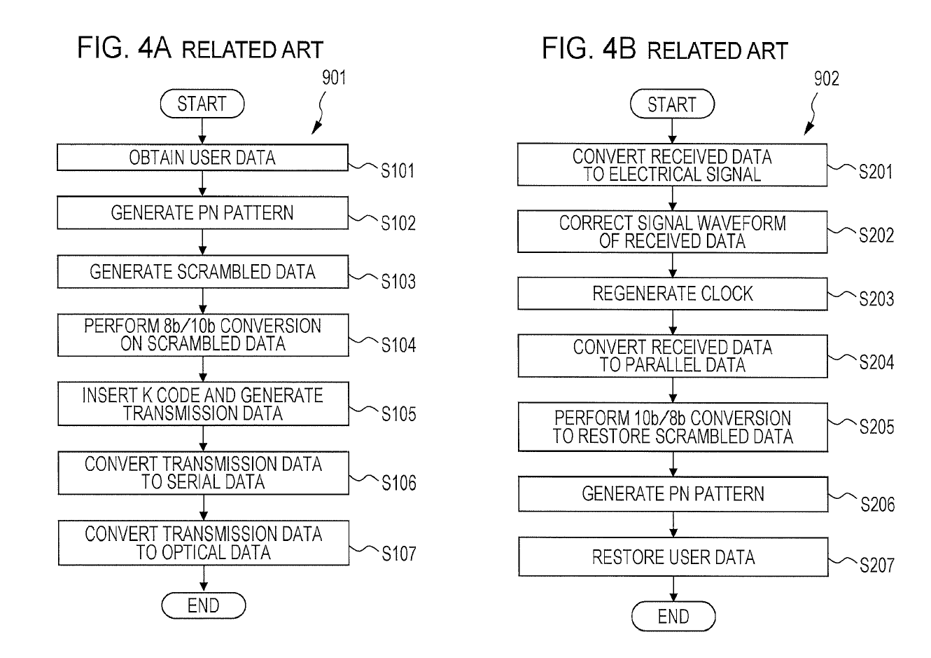

FIG. 4A is a flowchart illustrating the processing of the transmission device 901, and FIG. 4B is a flowchart illustrating the processing of the reception device 902.

First, in the transmission processing performed by the transmission device 901, the diffusion PN pattern generation circuit 931 obtains user data including multiple D codes #0 to #n having a byte length of (n+1), and an idle byte between two sets of D codes #0 to #n from a logic circuit (S101). Subsequently, the diffusion PN pattern generation circuit 931 generates the PN pattern which has been generated using a predetermined initial value (S102). When generating a PN pattern, the diffusion PN pattern generation circuit 931 initializes the PN pattern each time an idle byte is detected in the user data. Subsequently, the diffusion circuit 932 generates scrambled data by calculating exclusive OR between a PN pattern having a period corresponding to D codes #0 to #n included in the obtained user data, and user data inputted from a calculation circuit (S103).

Subsequently, the transmission control circuit 912 performs protocol control of 8b/10b, and converts the user data to 10-bit date for every 8 bits (S104). Subsequently, the transmission control circuit 912 generates transmission data by inserting K code into an idle byte of the user data (S105). Subsequently, the parallel-serial conversion circuit 913 converts the transmission data to serial data (S106). The E/O conversion circuit 914 then converts the transmission data, which has been converted to serial data by the transmission control circuit 912, to an optical signal, and transmits the optically converted transmission signal to the reception device 902 via the optical fiber 903 (S107).

In contrast, in the reception processing performed by the reception device 902, the O/E conversion circuit 921 converts the reception signal received via the optical fiber 903 to reception data which is an electrical signal (S201). Subsequently, the equalizer 922 corrects the waveform of a signal indicating the reception data converted to an electrical signal (S202). Subsequently, the CDR circuit 923 reproduces a clock from the reception data with the signal waveform corrected by the equalizer 922 (S203). Subsequently, the serial-parallel conversion circuit 924 converts the reception data with the signal waveform corrected by the equalizer 922 to parallel data using the clock reproduced by the CDR circuit 923 (S204).

Subsequently, the reception control circuit 925 performs protocol control of 8b/10b, and restores the scrambled data from the reception data converted to parallel data by the serial-parallel conversion circuit 924 (S205). Subsequently, the inverse diffusion PN pattern generation circuit 941 generates the PN pattern which has been generated using a predetermined initial value (S206). The initial value used by the inverse diffusion PN pattern generation circuit 941 for generation of a PN pattern is the same as the initial value used by the diffusion PN pattern generation circuit 931. Subsequently, the inverse diffusion circuit 942 restores the user data by calculating exclusive OR between the PN pattern generated by the inverse diffusion PN pattern generation circuit 941, and the scrambled data (S207).

In the transmission system 900, the transmission device 901 and the reception device 902 performs diffusion and inverse diffusion of the user data using a PN pattern generated using the same initial value. Since the transmission device 901 initializes the PN pattern according to detection of an idle byte and the reception device 902 initializes the PN pattern according to detection of a K code corresponding to the idle byte, the diffusion processing of the transmission device 901 and the inverse diffusion processing of the reception device 902 are synchronized.

However, in the transmission system 900, a PN pattern is generated using a single initial value that is used by both the transmission device 901 and the reception device 902, and thus the generated PN pattern includes the same pattern for every period corresponding to the D code. Also, for a D code included in the user data, the same data may be allocated at the same byte position as in another D code.

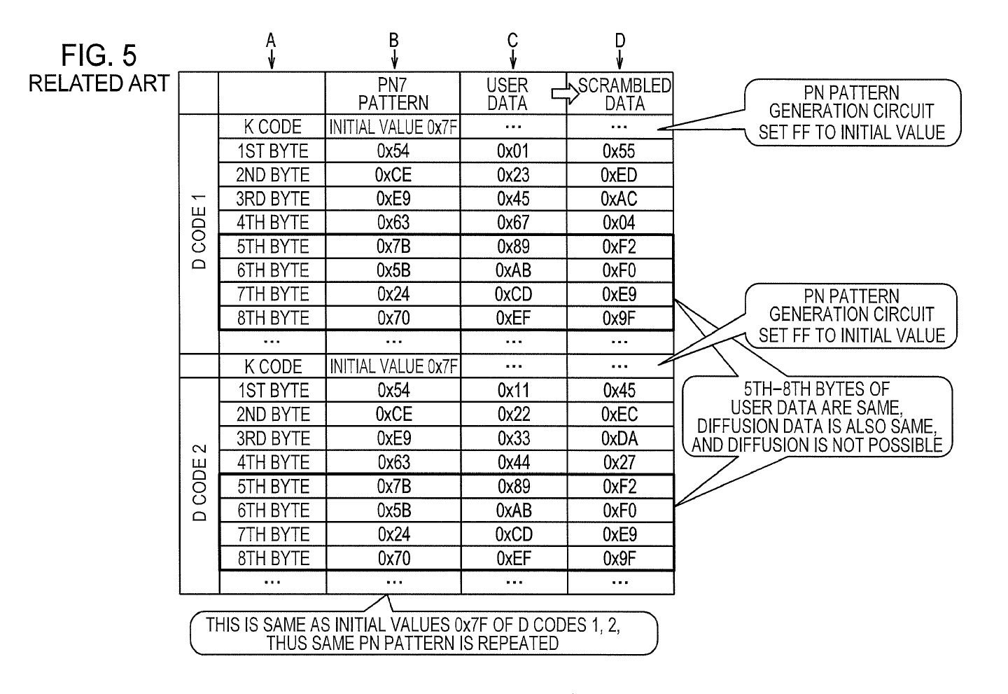

FIG. 5 is a diagram for explaining a problem in the transmission system 900. In FIG. 5, the column indicated by arrow A represents the name of each of bytes in the user data to be transmitted, the column indicated by arrow B represents generated PN patterns, and the column indicated by arrow C represents an example of data of each byte included in D code of the user data. In addition, the column indicated by arrow D represents scrambled data generated by each PN pattern in the column indicated by the arrow B, and data in the column indicated by the arrow C.

In the example illustrated in FIG. 5, the transmission device 901 initializes the PN pattern using an initial value of 0x7F for each idle byte in which a K code is inserted, and thus as illustrated in the column indicated by the arrow B, the same PN pattern is generated at the same byte position in both the D codes 1 and 2. Specifically, in both the D codes 1 and 2, the PN pattern is 0x54→0xCE→0xE9→0x63→0x7B→0x5B→0x24→0x70 from the 1st byte to the 8th byte.

Also, in the example illustrated in FIG. 5, as illustrated in the column indicated by the arrow C, the user data from the 5th byte to the 8th byte in both the D codes 1 and 2 is the same data: 0x89→0xAB→0xCD→0xEF.

In the example illustrated in FIG. 5, since the PN pattern is the same in the 1st byte to the 8th byte and the user data is the same in the 4th byte to the 8th byte between the D codes 1 and 2, generated scrambled data is the same in the 4th byte to the 8th byte. In the example illustrated in FIG. 5, since the generated scramble data is the same in the 4th byte to the 8th byte, frequency components corresponding to the 4th byte to the 8th byte of the scrambles data are not diffused.

As illustrated in FIG. 5, in the transmission systems 900, specific frequency components may not be diffused. When a pattern, in which frequency components are not diffused, is included in transmission data, the equalizer 922 disposed in the reception device 902 may not be able to accurately correct the signal waveform of the transmission data. When the equalizer 922 is unable to accurately correct the signal waveform of the transmission data and loss of a D code occurs, retransmission of the lost D code is performed by a higher-level layer, which causes a problem in that transmission volume increases, and the band of a transmission path is congested.

The transmission system according to an embodiment addresses such a problem.

<Configuration and Function of Transmission System According to First Embodiment>

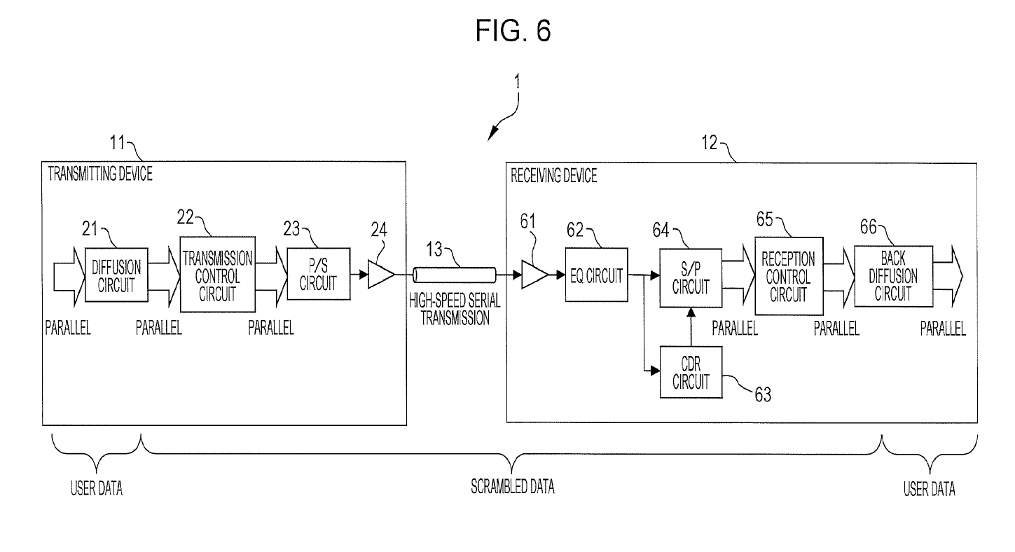

FIG. 6 is a diagram illustrating a transmission system according to a first embodiment.

A transmission system 1 has a transmission device 11, a reception device 12, and an optical fiber 13 that is a transmission path between the transmission device 11 and the reception device 12.

The transmission device 11 has a diffusion circuit 21, a transmission control circuit 22, a parallel-serial conversion circuit 23, and an E/O conversion circuit 24. The transmission device 11 generates a PN pattern using the 1st byte data of each D code as the initial value instead of using a predetermined initial value. The generation of a PN pattern using the 1st byte data of each D code as the initial value allows the transmission device 11 to generate a different PN pattern for each D code.

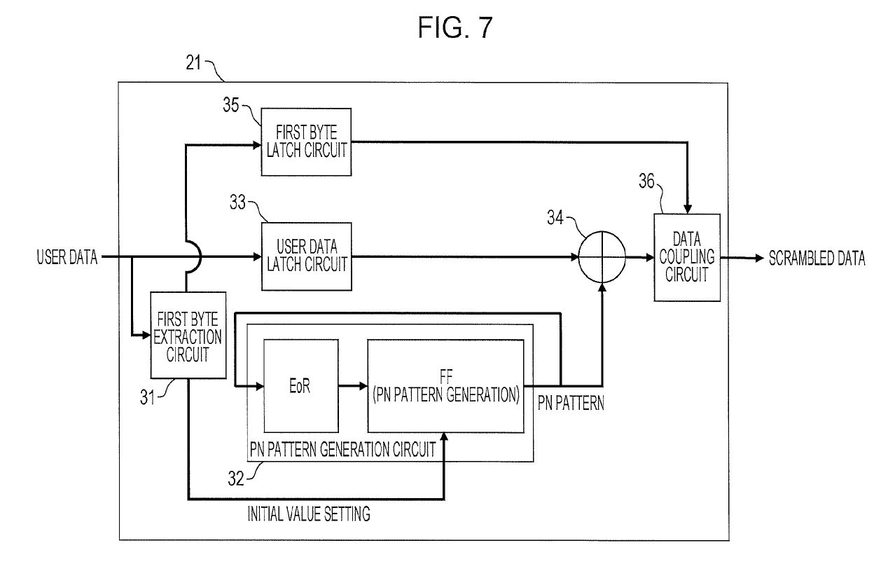

FIG. 7 is an internal circuit diagram of the diffusion circuit 21.

The diffusion circuit 21 has a first byte extraction circuit 31, a PN pattern generation circuit 32, a user data latch circuit 33, a diffusion calculation circuit 34, a first byte latch circuit 35, and a data coupling circuit 36. The first byte extraction circuit 31 is also referred to as a transmission-side data extraction circuit, the PN pattern generation circuit 32 is also referred to as a transmission-side random pattern generation circuit, and the data coupling circuit 36 is also referred to as a transmission data coupling circuit. The first byte extraction circuit 31 detects an idle byte included in user data, obtains the 1st byte data of the D code located next to the idle byte, and determines an initial value used for generation of a PN pattern, according to the obtained 1st byte data. The first byte extraction circuit 31 outputs the determined initial value to the PN pattern generation circuit 32, and outputs the obtained the 1st byte data to the first byte latch circuit 35. The PN pattern generation circuit 32 generates a PN pattern using the initial value inputted from the first byte extraction circuit 31. The user data latch circuit 33 adjusts the timing of the user data so that calculation is performed on the PN pattern generated by the PN pattern generation circuit 32 and the data located at a desired byte position of the D code included in the user data. Specifically, the user data latch circuit 33 adjusts the timing of the user data so that calculation is performed on the PN pattern first generated by the PN pattern generation circuit 32 using the initial value and the 2nd byte data of the D code included in the user data. The diffusion calculation circuit 34 generates scrambled data by calculating exclusive OR between the PN pattern generated by the PN pattern generation circuit 32 and the user data adjusted in timing by the user data latch circuit 33. The first byte latch circuit 35 adjusts the timing of the 1st byte data so that the phase of the 1st byte data extracted by the first byte extraction circuit 31 matches the phase of the 1st byte of the scrambled data generated by the diffusion calculation circuit 34. The data coupling circuit 36 couples the 1st byte data adjusted in timing by the first byte latch circuit 35 to the 1st byte of the scrambled data.

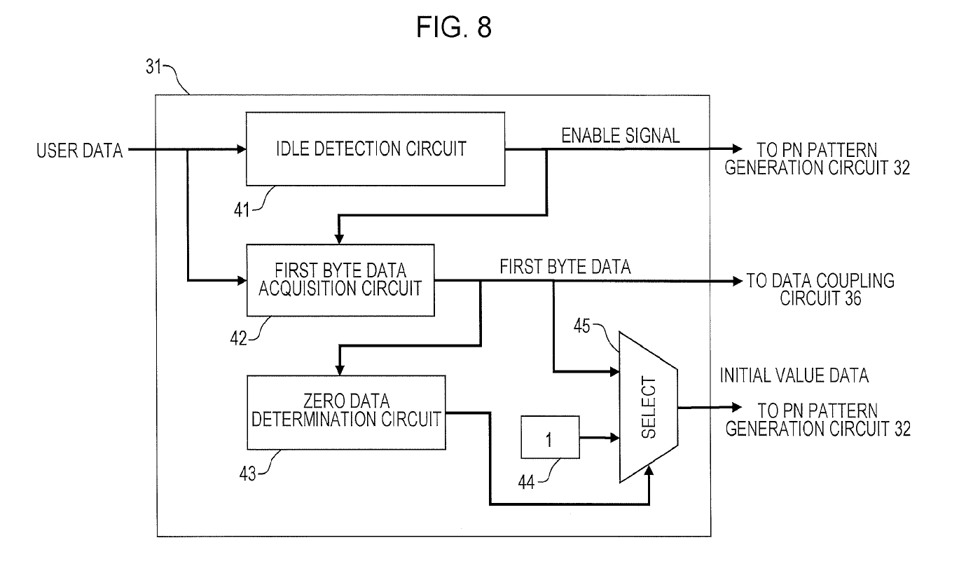

FIG. 8 is an internal circuit diagram of the first byte extraction circuit 31.

The first byte extraction circuit 31 has an idle detection circuit 41, a first byte data acquisition circuit 42, a zero-data determination circuit 43, a signal value storage circuit 44, and a selection circuit 45. When detecting an idle byte from inputted user data, the idle detection circuit 41 outputs an enable signal to the PN pattern generation circuit 32 and the first byte data acquisition circuit 42. When user data is sequentially inputted, the first byte data acquisition circuit 42 acquires the user data as the 1st byte data at the moment when an enable signal is inputted from the idle detection circuit 41. The first byte data acquisition circuit 42 outputs the acquired 1st byte data to the data coupling circuit 36, the zero data determination circuit 43, and the selection circuit 45. The zero data determination circuit 43 determines whether 7 bits of data, excluding the most significant bit, of the 1st byte data inputted from the first byte data acquisition circuit 42 are “0”. The zero data determination circuit 43, when determining that 7 bits of data, excluding the most significant bit, of the 1st byte data inputted are “0”, outputs a zero-determination signal to the selection circuit 45. The signal value storage circuit 44 is a non-volatile memory such as a ROM, and stores 7 bits of “1”. The selection circuit 45 selects one of the 1st byte data inputted from the first byte data acquisition circuit 42 and 7 bits of data indicating “1” stored in the signal value storage circuit 44. When a zero-determination signal is not inputted, as the initial value, the selection circuit 45 selects 7 bits of data, excluding the most significant bit, of the 1st byte data inputted from the first byte data acquisition circuit 42. On the other hand, when a zero determination signal is inputted, as the initial value, the selection circuit 45 selects the 7 bits of data indicating “1” stored in the signal value storage circuit 44. The selection circuit 45 outputs the selected data to the PN pattern generation circuit as the initial value.

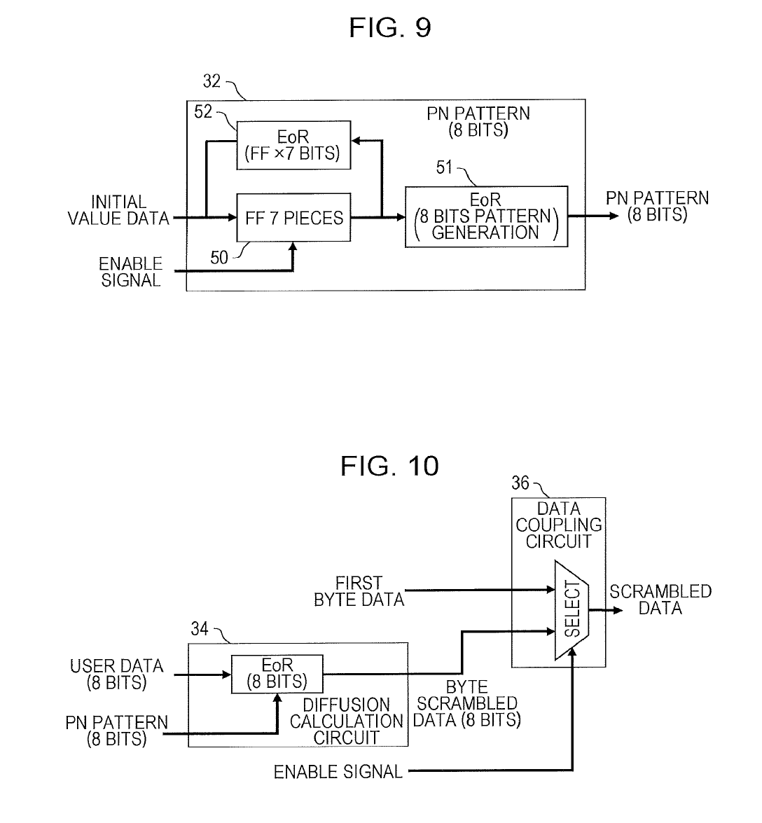

FIG. 9 is an internal circuit diagram of the PN pattern generation circuit 32.

The PN pattern generation circuit 32 has a data latch circuit 50, a first calculation circuit 51, and a second calculation circuit 52. The data latch circuit 50 has seven flip-flops, and receives input of an enable signal and an initial value from the first byte extraction circuit 31, and input of a PN pattern from the second calculation circuit 52. The data latch circuit 50 selects and stores one of an initial value inputted from the first byte extraction circuit 31 and a PN pattern inputted from the second calculation circuit 52, according to the presence or absence of input of an enable signal. When an enable signal is inputted, the data latch circuit 50 stores the initial value inputted from the first byte extraction circuit 31. On the other hand, when an enable signal is not inputted, the data latch circuit 50 stores the PN pattern inputted from the second calculation circuit 52. Each of the first calculation circuit 51 and the second calculation circuit 52 generates a PN pattern by calculating PN7(X⁷+X⁶+1) from the data stored in the data latch circuit 50. The first calculation circuit 51 outputs the calculated PN pattern to the diffusion calculation circuit 34, and the second calculation circuit 52 outputs the calculated PN pattern to the data latch circuit 50.

FIG. 10 is a diagram illustrating the connection relationship between the diffusion calculation circuit 34 and the data coupling circuit 36.

The diffusion calculation circuit 34 receives input of 1 byte of PN pattern from the PN pattern generation circuit 32, and input of each byte of the data of a D code included in the user data from the user data latch circuit 33. The diffusion calculation circuit 34 has eight EOR circuits, and generates the first byte of byte scramble data by calculating exclusive OR between the 1st byte of the PN pattern and the data of D code inputted for each byte. The diffusion calculation circuit 34 sequentially outputs the generated byte scrambled data to the data coupling circuit 36.

The data coupling circuit 36 receives input of the 1st byte data from the first byte latch circuit 35, input of byte scrambled data from the diffusion calculation circuit 34 sequentially, and input of an enable signal from the first byte extraction circuit 31. When an enable signal is inputted, the data coupling circuit 36 selects and outputs the 1st byte data inputted from the first byte latch circuit 35. On the other hand, when an enable signal is not inputted, the data coupling circuit 36 selects and outputs byte scrambled data sequentially inputted from the diffusion calculation circuit 34. When an enable signal is inputted, the data coupling circuit 36 outputs the 1st byte data, thereby inserting the 1st byte data at the 1st byte position of the D code. When an enable signal is not inputted, the data coupling circuit 36 sequentially outputs scrambled data, thereby inserting byte scrambled data at each of the 2nd byte position to the nth byte position of the D code. The data coupling circuit 36 inserts the 1st byte data at the 1st byte position of the D code, and inserts scrambled data at each of the 2nd byte position to the nth byte position of the D code, thereby forming the scrambled data.

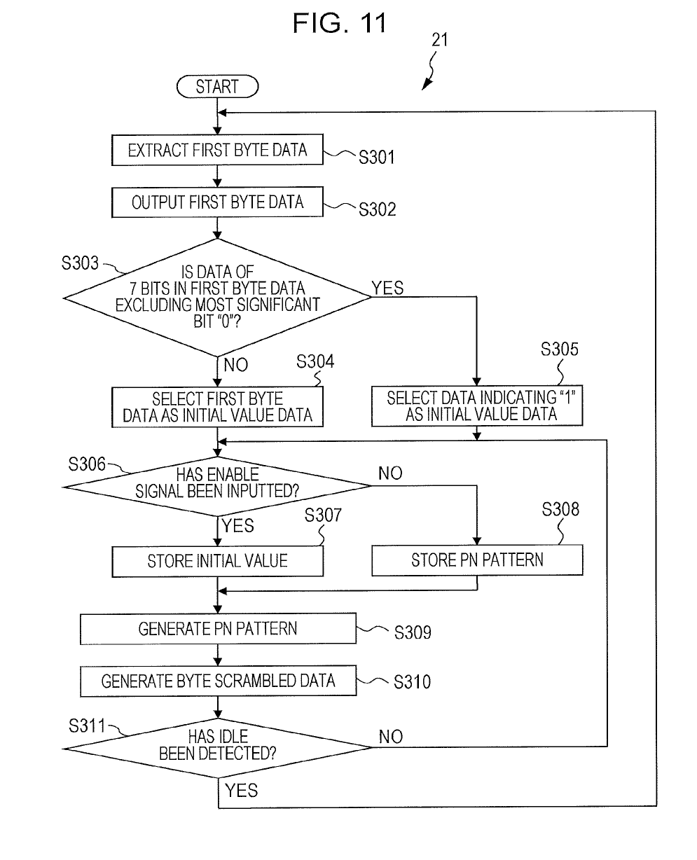

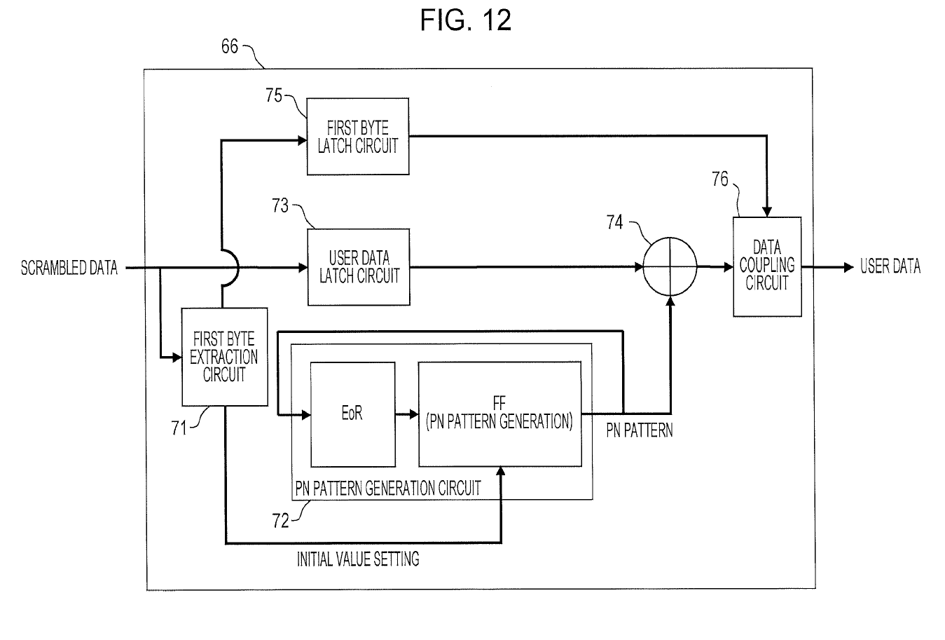

FIG. 11 is a flowchart illustrating the operation of the diffusion circuit 21.

First, the first byte extraction circuit 31 extracts the 1st byte data of D code of the user data as the 1st byte data (S301). Specifically, when detecting an idle byte from inputted user data, the idle detection circuit 41 outputs an enable signal to the first byte data acquisition circuit 42. The first byte data acquisition circuit 42 acquires user data as the 1st byte data at the moment when an enable signal is inputted from the idle detection circuit 41.

Subsequently, the data coupling circuit 36 selects and outputs the 1st byte data (S302).

Subsequently, the zero data determination circuit 43 determines whether 7 bits of data, excluding the most significant bit, of the 1st byte data acquired by the first byte data acquisition circuit 42 are “0” (S303). When the zero data determination circuit 43 determines that not all 7 bits of data, excluding the most significant bit, of the 1st byte data are “0” (NO in S303), the selection circuit 45 selects 7 bits of data, excluding the most significant bit, of the 1st byte data as the initial value (S304). Also, when the zero data determination circuit 43 determines that 7 bits of data, excluding the most significant bit, of the 1st byte data are “0” (YES in S303), the selection circuit 45 selects data indicating “1” stored in the signal value storage circuit 44 as the initial value (S305). Subsequently, the data latch circuit 50 determines whether an enable signal is inputted (S306). When it is determined that an enable signal is inputted (YES in S306), the data latch circuit 50 stores the initial value selected by the selection circuit 45 (S307). Subsequently, both the first calculation circuit 51 and the second calculation circuit 52 each generate a PN pattern using the initial value stored in the data latch circuit 50 (S309).

Subsequently, the diffusion calculation circuit 34 generates the 2nd byte of byte scramble data by performing calculation on the 2nd byte data and the PN pattern calculated by the first calculation circuit 51 (S310). The processing in S306 to S311 is repeated until the idle detection circuit 41 detects an idle byte from the inputted user data (YES in S311). The data latch circuit 50 determines that an enable signal is not inputted (NO in S306), and stores the PN pattern calculated by the second calculation circuit 52 (S308). Subsequently, both the first calculation circuit 51 and the second calculation circuit 52 each generate a PN pattern using the PN pattern stored in the data latch circuit 50 (S309). Subsequently, the diffusion calculation circuit 34 generates the Nth byte of byte scrambled data by performing calculating on the inputted Nth byte data (N is an integer of 3 or greater) and the PN pattern calculated by the first calculation circuit 51 (S310).

When the idle detection circuit 41 detects an idle byte from the inputted user data (YES in S311), the processing returns to S301.

The configuration and function of the transmission control circuit 22, the parallel-serial conversion circuit 23, and the E/O conversion circuit 24 are the same as the configuration and function of the transmission control circuit 912, the parallel-serial conversion circuit 913, and the E/O conversion circuit 914, thus a detailed description is omitted here. The parallel-serial conversion circuit 23 and the E/O conversion circuit 24 are each a transmission signal generation circuit that generates a transmission signal from transmission data.

The reception device 12 has an O/E conversion circuit 61, an equalizer 62, a CDR circuit 63, a serial-parallel conversion circuit 64, a reception control circuit 65, and an inverse diffusion circuit 66. Similarly to the transmission device 11, the reception device 12 generates a PN pattern using the 1st byte data of each D code as the initial value instead of using a predetermined initial value. Similarly to the transmission device 11, the reception device 12 generates a PN pattern using the 1st byte data of each D code as the initial value, and thus the inverse diffusion processing of the reception device 12 and the diffusion processing of the transmission device 11 are synchronized.

The configuration and function of the O/E conversion circuit 61 to the reception control circuit 65 are the same as the configuration and function of the O/E conversion circuit 921 to the reception control circuit 925, thus a detailed description is omitted here. The O/E conversion circuit 61, the equalizer 62, the CDR circuit 63, and the serial-parallel conversion circuit 64 are each a reception data generation circuit that generates reception data from a reception signal.

FIG. 12 is an internal circuit diagram of the inverse diffusion circuit 66.

The inverse diffusion circuit 66 has a first byte extraction circuit 71, a PN pattern generation circuit 72, a user data latch circuit 73, an inverse diffusion calculation circuit 74, a first byte latch circuit 75, and a data coupling circuit 76. The first byte extraction circuit 71 is also referred to as a reception-side data extraction circuit, the PN pattern generation circuit 72 is also referred to as a reception-side random pattern generation circuit, and the data coupling circuit 76 is also referred to as a reception data coupling circuit. The configuration of each of the PN pattern generation circuit 72 to the data coupling circuit 76 is the same as the configuration of each of the PN pattern generation circuit 32 to the data coupling circuit 36, thus a detailed description is omitted here.

The first byte extraction circuit 71 detects K code included in scrambled data, obtains the 1st byte of the D code located next to the K code, and determines an initial value used for generation of a PN pattern according to the obtained 1st byte. The first byte extraction circuit 71 outputs the determined initial value to the PN pattern generation circuit 72, and outputs the obtained 1 byte to the first byte latch circuit 75. The PN pattern generation circuit 72 generates a PN pattern using the initial value inputted from the first byte extraction circuit 71. The user data latch circuit 73 adjusts the timing of the user data so that calculation is performed on the PN pattern generated by the PN pattern generation circuit 72 and the data located at a desired byte position of the D code included in the user data. Specifically, the user data latch circuit 73 adjusts the timing of the user data so that calculation is performed on the PN pattern first generated by the PN pattern generation circuit 72 using the initial value and the 2nd byte data of the D code included in the user data. The inverse diffusion calculation circuit 74 generates scrambled data by calculating exclusive OR between the PN pattern generated by the PN pattern generation circuit 72 and the user data adjusted in timing by the user data latch circuit 73. The first byte latch circuit 75 adjusts the timing of the 1st byte data so that the phase of the 1st byte data extracted by the first byte extraction circuit 71 matches the phase of the 1st byte of the scrambled data generated by the inverse diffusion calculation circuit 74. The data coupling circuit 76 couples the 1st byte data adjusted in timing by the first byte latch circuit 75 to the 1st byte of the scrambled data.

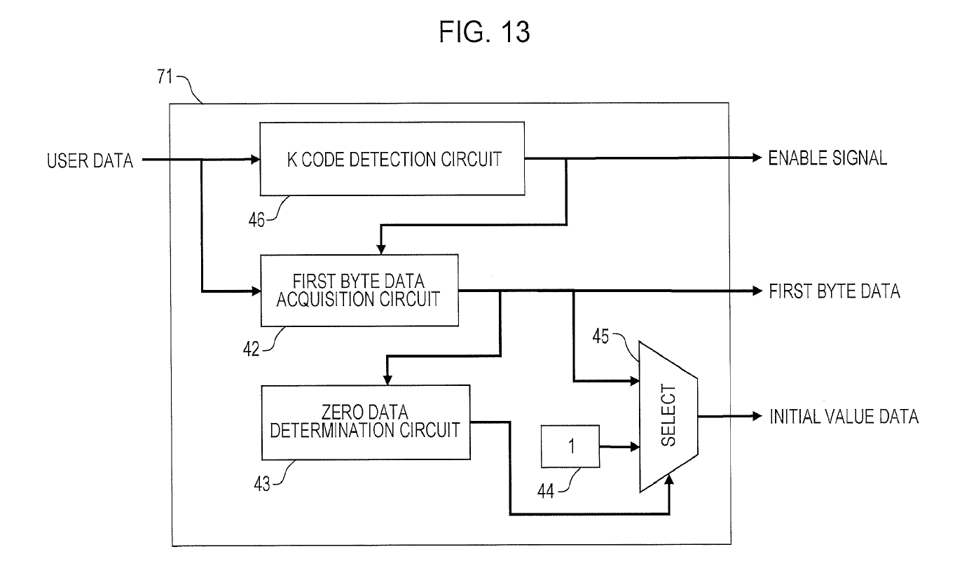

FIG. 13 is an internal circuit diagram of the first byte extraction circuit 71.

The first byte extraction circuit 71 differs from the first byte extraction circuit 31 in that the first byte extraction circuit 71 has a K code detection circuit 46 instead of the idle detection circuit 41. The configuration and function of the components of the first byte extraction circuit 71 other than the K code detection circuit 46 are the same as the configuration and function of the components of the first byte extraction circuit 31 which are labeled with the same symbols, thus a detailed description is omitted here.

When detecting K code from inputted user data, the K code detection circuit 46 outputs an enable signal to the PN pattern generation circuit 72 and the first byte data acquisition circuit 42. When user data is sequentially inputted, the first byte data acquisition circuit 42 acquires the user data as the 1st byte data at the moment when an enable signal is inputted from the K code detection circuit 46.

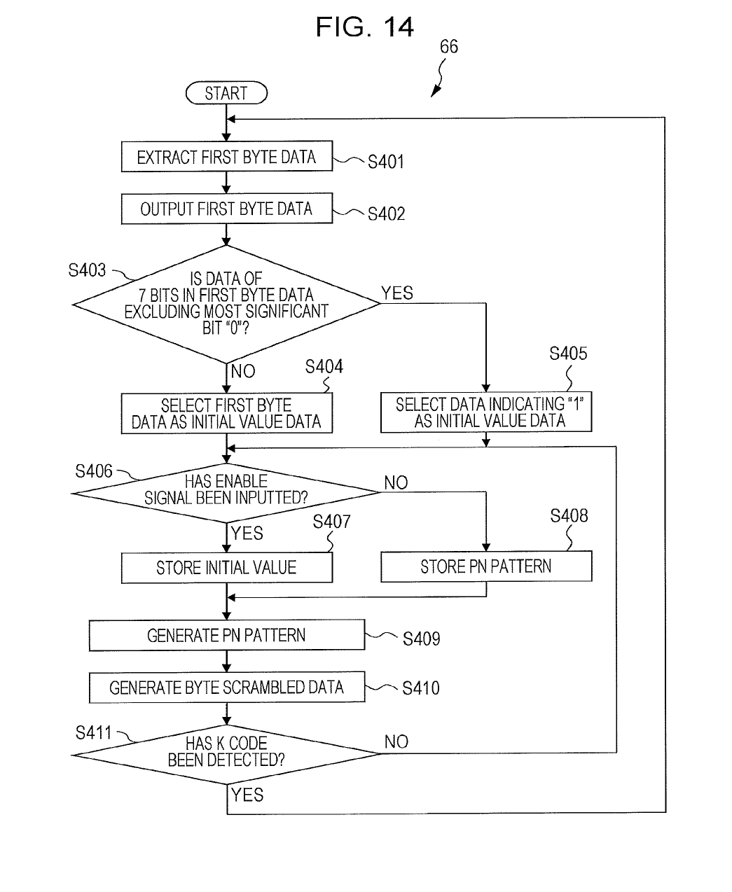

FIG. 14 is a flowchart illustrating the operation of the inverse diffusion circuit 66.

First, the first byte extraction circuit 71 extracts the 1st byte data as the first byte data (S401). Specifically, when detecting K code from inputted user data, the K code detection circuit 46 outputs an enable signal to the first byte data acquisition circuit 42. The first byte data acquisition circuit 42 acquires user data as the 1st byte data at the moment when an enable signal is inputted from the K code detection circuit 46. The processing in S402 to S410 is the same as the processing in S302 to S310, thus a detailed description is omitted here.

The processing in S406 to S411 is repeated until the K code detection circuit 46 detects K code from the inputted user data (YES in S411). When the K code detection circuit 46 detects K code from the inputted user data (YES in S411), the processing returns to S401.

<Configuration and Function of Transmission System According to Second Embodiment>

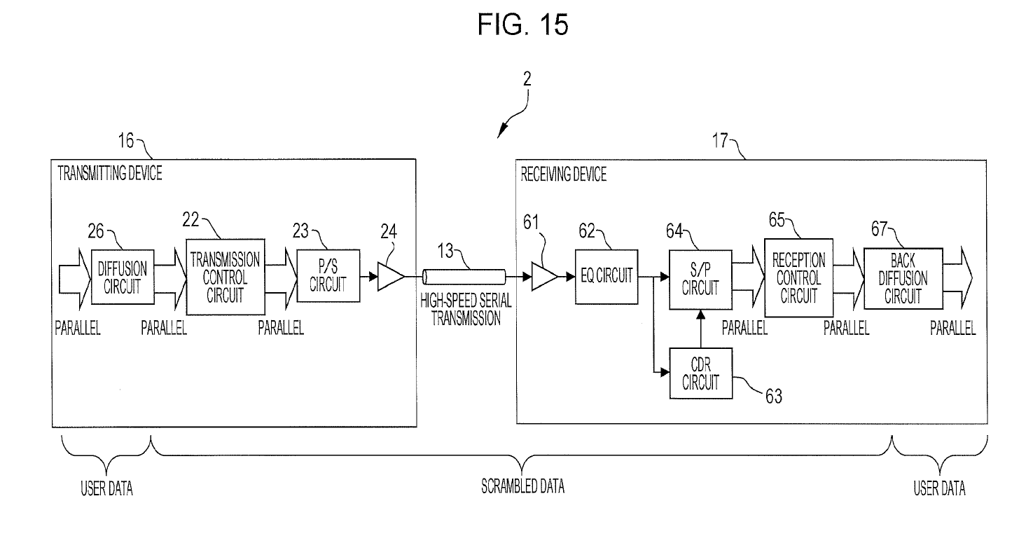

FIG. 15 is a diagram illustrating a transmission system according to a second embodiment.

A transmission system 2 differs from the transmission system 1 in that the transmission system 2 has a transmission device 16 and a reception device 17 instead of the transmission device 11 and the reception device 12. The transmission device 16 and the reception device 17 differs from the transmission device 11 and the reception device 12 in that the transmission device 16 and the reception device 17 each generate a PN pattern using data at a predetermined byte position as an initial value instead of using the 1st byte data of each D code.

The transmission device 16 differs from the transmission device 11 in that transmission device 16 has a diffusion circuit 26 instead of the diffusion circuit 21, and the reception device 17 differs from the reception device 12 in that the reception device 17 has an inverse diffusion circuit 67 instead of the inverse diffusion circuit 66. The configuration and function of the components of the transmission system 2 other than the diffusion circuit 26 and the inverse diffusion circuit 67 are the same as the configuration and function of the components of the transmission system 1 which are labeled with the same symbols, thus a detailed description is omitted here.

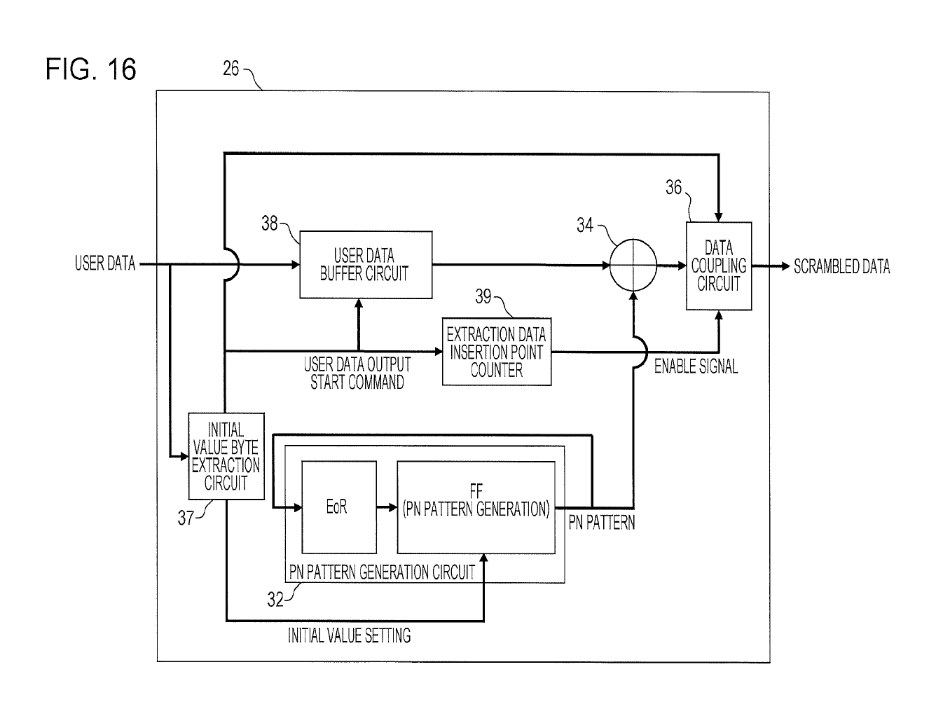

FIG. 16 is an internal circuit diagram of the diffusion circuit 26.

The diffusion circuit 26 differs from the diffusion circuit 21 in that the diffusion circuit 26 has an initial value byte extraction circuit 37, a user data buffer circuit 38, and an extraction data insertion point counter 39 instead of the first byte extraction circuit 31, the user data latch circuit 33, and the first byte latch circuit 35. The configuration and function of the components of the diffusion circuit 26 other than the initial value byte extraction circuit 37 to the extraction data insertion point counter 39 are the same as the configuration and function of the components of the diffusion circuit 21 which are labeled with the same symbols, thus a detailed description is omitted here.

The initial value byte extraction circuit 37 is also referred to as a transmission-side data extraction circuit, and detects an idle byte included in the user data, obtains data of D code located at a predetermined byte position after the idle byte, and determines an initial value used for generation of a PN pattern according to the obtained data. The initial value byte extraction circuit 37 outputs the determined initial value to the PN pattern generation circuit 32, outputs the obtained data to the data coupling circuit 36, and outputs a user data output start command to the user data buffer circuit 38 and the extraction data insertion point counter 39. The user data buffer circuit 38 is FIFO, stores user data, and sequentially outputs the stored user data according to input of a user data output start command from the initial value byte extraction circuit 37. The extraction data insertion point counter 39 starts to count according to input of a user data output start command from the initial value byte extraction circuit 37, and outputs an enable signal to the data coupling circuit 36 after predetermined counts of byte.

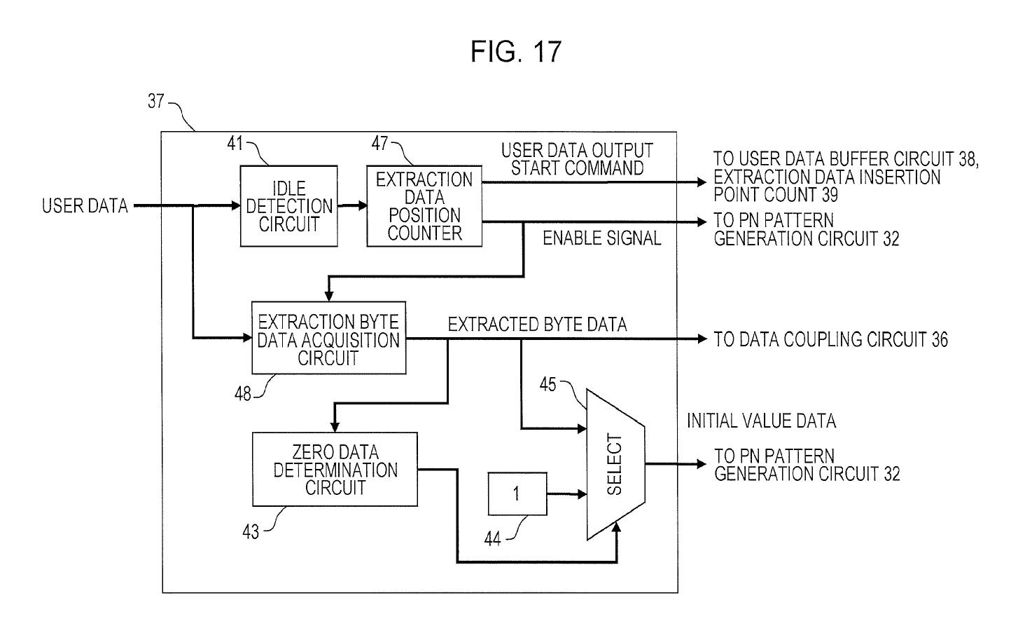

FIG. 17 is an internal circuit diagram of the initial value byte extraction circuit 37.

The initial value byte extraction circuit 37 differs from the first byte extraction circuit 31 in that the initial value byte extraction circuit 37 has an extraction data position counter 47. In addition, the initial value byte extraction circuit 37 differs from the first byte extraction circuit 31 in that the initial value byte extraction circuit 37 has an extraction byte data acquisition circuit 48 instead of the first byte data acquisition circuit 42. The configuration and function of the components of the first byte extraction circuit 71 other than the extraction data position counter 47 and the extraction byte data acquisition circuit 48 are the same as the configuration and function of the components of the first byte extraction circuit 31 which are labeled with the same symbols, thus a detailed description is omitted here.

The extraction data position counter 47 starts to count according to input of an enable signal from the idle detection circuit 41, and outputs an enable signal to the PN pattern generation circuit 32 and the extraction byte data acquisition circuit 48 after predetermined counts of byte. In addition, after predetermined counts of byte since the start of count, the extraction data position counter 47 outputs a user data output start command to the user data buffer circuit 38 and the extraction data insertion point counter 39.

When user data is sequentially inputted, the extraction byte data acquisition circuit 48 acquires the user data as the extraction byte data at the moment when an enable signal is inputted from the idle detection circuit 41.

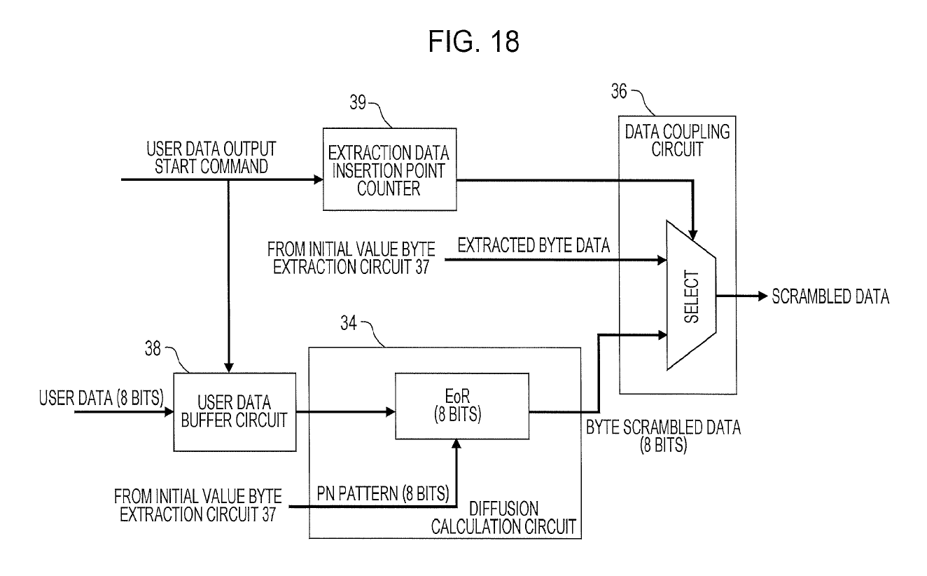

FIG. 18 is a diagram illustrating the connection relationship between the diffusion calculation circuit 34, the data coupling circuit 36, the user data buffer circuit 38, and the extraction data insertion point counter 39.

The user data buffer circuit 38 stores user data, and sequentially outputs the stored user data according to a user data output start command inputted from the initial value byte extraction circuit 37. The diffusion calculation circuit 34 receives input of 1 byte of PN pattern from the PN pattern generation circuit 32, and input of each byte of the data of a D code included in the user data from the user data buffer circuit 38. The extraction data insertion point counter 39 starts to count according to input of a user data output start command from the initial value byte extraction circuit 37, and outputs an enable signal to the data coupling circuit 36 after predetermined counts of byte. When an enable signal is inputted, the data coupling circuit 36 selects and outputs the extraction byte data inputted from the initial value byte extraction circuit 37. On the other hand, when an enable signal is not inputted, the data coupling circuit 36 selects and outputs the byte scrambled data sequentially inputted from the diffusion calculation circuit 34. When an enable signal is inputted, the data coupling circuit 36 outputs the extraction byte data, thereby inserting the extraction byte data at a predetermined byte position of the D code. When an enable signal is not inputted, the data coupling circuit 36 sequentially outputs scrambled data, thereby inserting the byte scrambled data at each byte other than a predetermined byte of the D code.

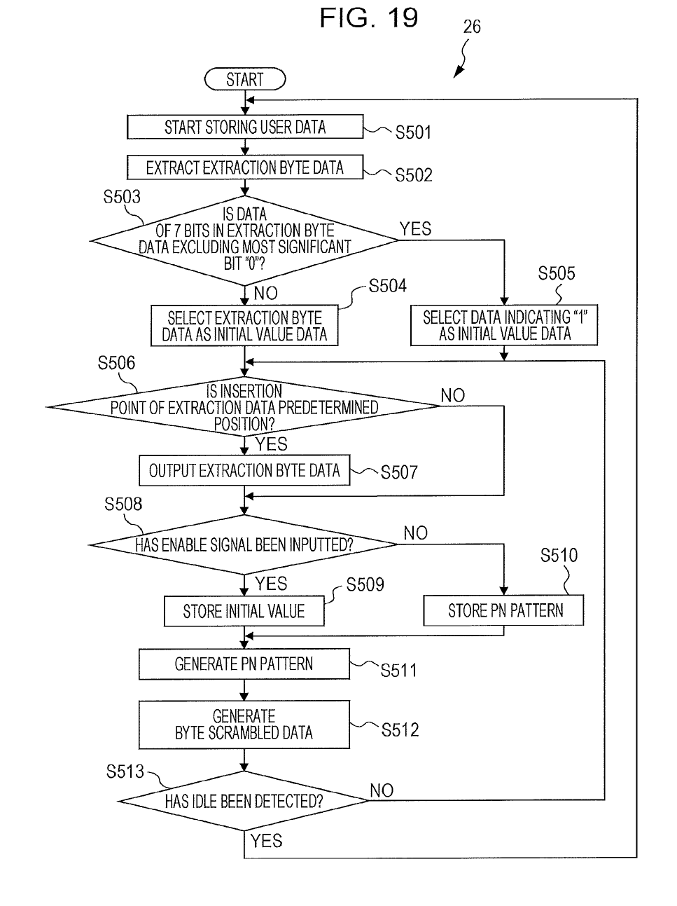

FIG. 19 is a flowchart illustrating the operation of the diffusion circuit 21.

First, the user data buffer circuit 38 starts to store inputted user data (S501). Subsequently, the initial value byte extraction circuit 37 extracts the data at a predetermined byte position of D code of the user data as extraction byte data (S502). Specifically, when detecting an idle byte from the inputted user data, the idle detection circuit 41 outputs an enable signal to the extraction data position counter 47. The extraction data position counter 47 starts to count according to input of an enable signal from the idle detection circuit 41, and outputs an enable signal to the extraction byte data acquisition circuit 48 after predetermined counts of byte. The extraction byte data acquisition circuit 48 acquires the user data as the extraction byte data at the moment when an enable signal is inputted from the extraction data position counter 47.

Subsequently, the zero data determination circuit 43 determines whether or not 7 bits of data, excluding the most significant bit, of the extraction byte data acquired by the extraction byte data acquisition circuit 48 are “0” (S503). When the zero data determination circuit 43 determines that not all 7 bits of data, excluding the most significant bit, of the extraction byte data are “0” (NO in S503), the selection circuit 45 selects 7 bits of data, excluding the most significant bit, of the extraction byte data as the initial value (S504). Also, when the zero data determination circuit 43 determines that 7 bits of data, excluding the most significant bit, of the extraction byte data are “0” (YES in S503), the selection circuit 45 selects data indicating “1” stored in the signal value storage circuit 44 as the initial value (S505). Subsequently, when the extraction data position counter 47 has not counted up to a predetermined byte position (NO in S506), the data latch circuit 50 determines whether or not an enable signal is inputted (S508). When it is determined that an enable signal is inputted (YES in S508), the data latch circuit 50 stores the initial value selected by the selection circuit 45 (S508). Subsequently, both the first calculation circuit 51 and the second calculation circuit 52 generate a PN pattern using the PN pattern stored in the data latch circuit 50 (S511).

Subsequently, the diffusion calculation circuit 34 generates the 1st byte of byte scramble data by performing calculation on the 1st byte data and the PN pattern calculated by the first calculation circuit 51 (S512). The processing in S506 to S513 is repeated until the idle detection circuit 41 detects an idle byte from the inputted user data (YES in S513). The data latch circuit 50 determines that an enable signal is not inputted (NO in S508), and stores the PN pattern calculated by the second calculation circuit 52 (S510). Subsequently, both the first calculation circuit 51 and the second calculation circuit 52 each generate a PN pattern using the PN pattern stored in the data latch circuit 50 (S511). Subsequently, the diffusion calculation circuit 34 generates the Nth byte of byte scrambled data by performing calculating on the inputted Nth byte data (N is an integer of 2 or greater) and the PN pattern calculated by the first calculation circuit 51 (S512).

When the extraction data position counter 47 has counted up to a predetermined byte position (YES in S506), the data coupling circuit 36 selects and outputs extraction byte data (S507).

When the idle detection circuit 41 detects an idle byte from the inputted user data (YES in S513), the processing returns to S501.

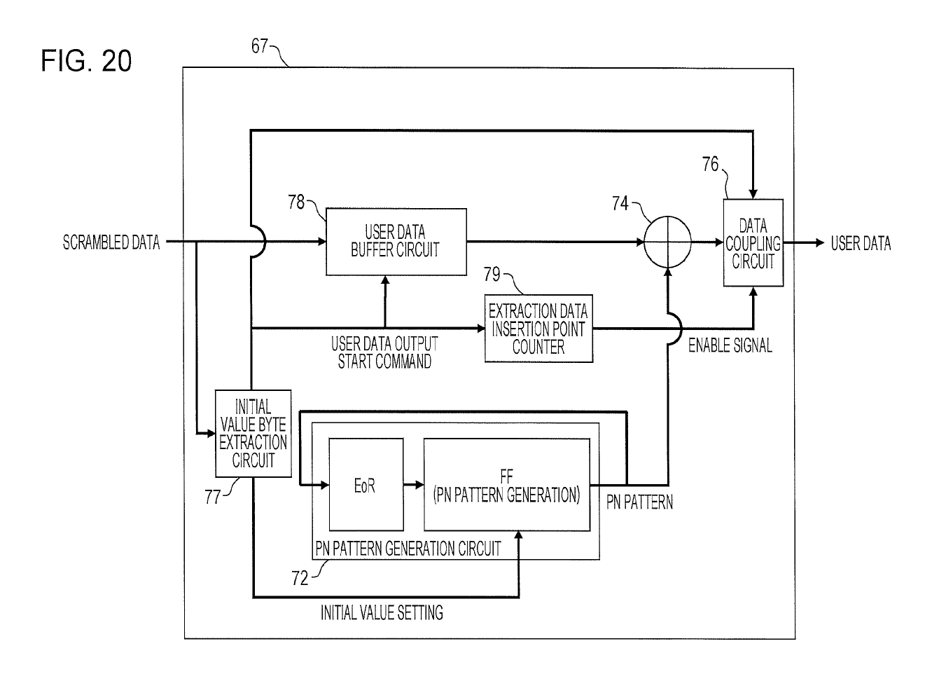

FIG. 20 is an internal circuit diagram of the inverse diffusion circuit 67.

The inverse diffusion circuit 67 differs from the inverse diffusion circuit 66 in that the inverse diffusion circuit 67 has an initial value byte extraction circuit 77, a user data buffer circuit 78, and an extraction data insertion point counter 79 instead of the first byte extraction circuit 71, the user data latch circuit 73, and the first byte latch circuit 75. The configuration and function of the components of the inverse diffusion circuit 67 other than the initial value byte extraction circuit 77 to the extraction data insertion point counter 79 are the same as the configuration and function of the components of the inverse diffusion circuit 66 which are labeled with the same symbols, thus a detailed description is omitted here.

The initial value byte extraction circuit 77 is also referred to as a reception-side data extraction circuit, and detects K code included in the user data, obtains data of D code located at a predetermined byte position after the K code, and determines an initial value used for generation of a PN pattern according to the obtained data. The initial value byte extraction circuit 77 outputs the determined initial value to the PN pattern generation circuit 72, outputs the obtained data to the data coupling circuit 76, and outputs a user data output start command to the user data buffer circuit 78 and the extraction data insertion point counter 79. The user data buffer circuit 78 stores user data, and sequentially outputs the stored user data according to a user data output start command inputted from the initial value byte extraction circuit 77. The extraction data insertion point counter 79 starts to count according to input of a user data output start command from the initial value byte extraction circuit 77, and outputs an enable signal to the data coupling circuit 76 after predetermined counts of byte.

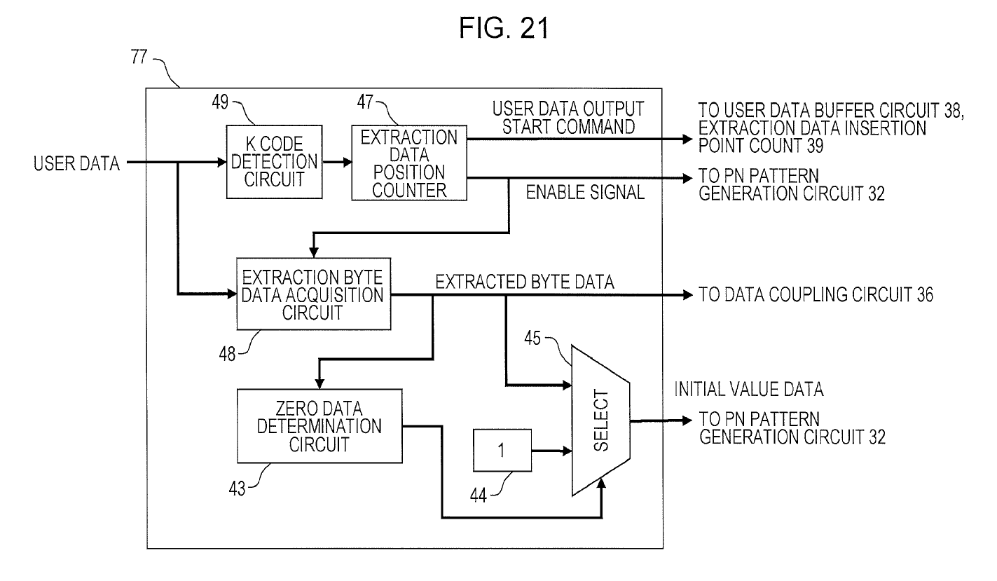

FIG. 21 is an internal circuit diagram of the initial value byte extraction circuit 77.

The initial value byte extraction circuit 77 differs from the initial value byte extraction circuit 37 in that the initial value byte extraction circuit 77 has a K code detection circuit 49 instead of the idle detection circuit 41. The configuration and function of the components of the initial value byte extraction circuit 77 other than the K code detection circuit 49 are the same as the configuration and function of the components of the initial value byte extraction circuit 37 which are labeled with the same symbols, thus a detailed description is omitted here.

When detecting K code from the inputted user data, the K code detection circuit 49 outputs an enable signal to the extraction data position counter 47.

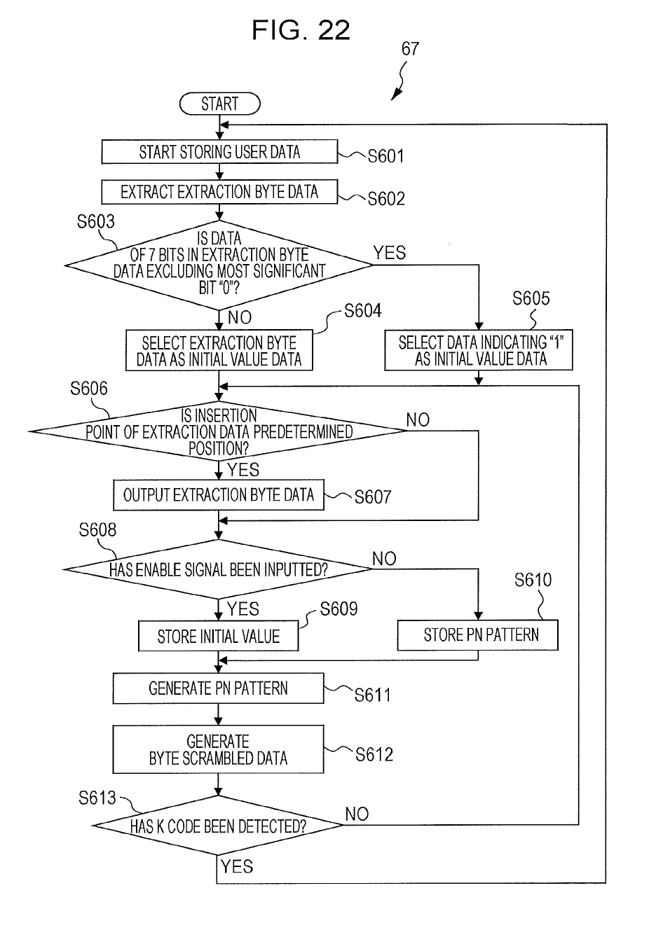

FIG. 22 is a flowchart illustrating the operation of the inverse diffusion circuit 67.

First, the user data buffer circuit 78 starts to store inputted user data (S601). Subsequently, the initial value byte extraction circuit 77 extracts data of extraction byte (S602). Specifically, when detecting K code from the inputted user data, the K code detection circuit 49 outputs an enable signal to the extraction data position counter 47. The extraction data position counter 47 starts to count according to input of an enable signal from the K code detection circuit 49, and outputs an enable signal to the extraction byte data acquisition circuit 48 after predetermined counts of byte. The extraction byte data acquisition circuit 48 acquires the user data as the extraction byte data at the moment when an enable signal is inputted from the extraction data position counter 47. The processing in S603 to S612 is the same as the processing in S503 to S512, thus a detailed description is omitted here.

The processing in S606 to S613 is repeated until the K code detection circuit 49 detects K code from the inputted user data (YES in S613). When the K code detection circuit 49 detects K code from the inputted user data (YES in S613), the processing returns to S601.

<Operation Effect of Transmission System According to Embodiment>

The transmission system according the embodiment generates a PN pattern using data included in the user data to be transmitted as the initial value, and thus the PN pattern has a low probability of exhibiting periodicity and there is a low probability that predetermined frequency components remain without being diffused.

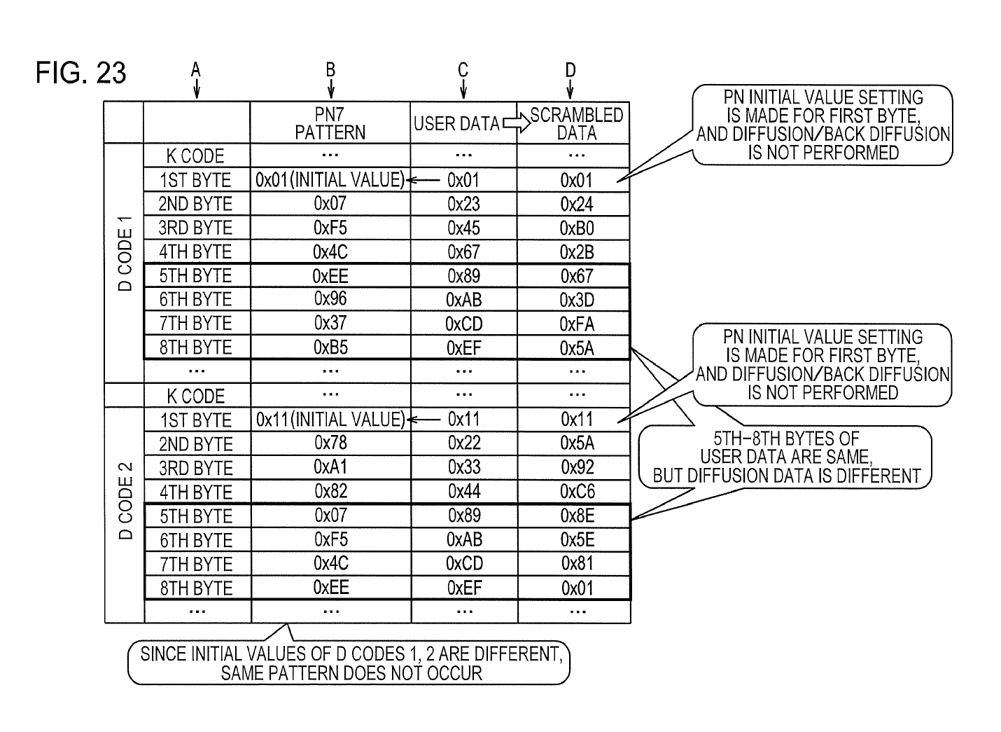

FIG. 23 is a diagram illustrating an example of generation of scrambled data in the transmission system 1. In FIG. 23, the column indicated by arrow A represents the name of each of bytes in the user data to be transmitted, the column indicated by arrow B represents generated PN patterns, and the column indicated by arrow C represents an example of data of each byte included in D code of the user data. In addition, the column indicated by arrow D represents scrambled data generated by each PN pattern in the column indicated by the arrow B, and data in the column indicated by the arrow C.

In the example illustrated in FIG. 23, the transmission system 1 initializes the PN pattern using the 1st byte data as the initial value, and thus as illustrated in the column indicated by the arrow B, different PN patterns are generated at the same byte position in both the D codes 1 and 2. Specifically, the PN patterns from the 2nd byte to the 8th byte are 0x07→0xF5→0x4C→0xEE→0x96→0x37→0xB5 in the D code 1, and 0x78→0xA1→0x82→0x07→0xF5→0x4C→0xEE in the D code 2.

In the example illustrated in FIG. 23, as illustrated in the column indicated by the arrow C, the user data from the 5th byte to the 8th byte in both the D codes 1 and 2 is the same data: 0x89→0xAB→0xCD→0xEF.

In the example illustrated in FIG. 23, the PN patterns are different from the 1st byte to the 8th byte between the D codes 1 and 2. Thus, although the user data are the same from the 4th byte to the 8th byte, the 1st byte to the 8th byte of the generated scrambled data are all different. In the example illustrated in FIG. 23, since the generated scrambled data are different from the 1st byte to the 8th byte, frequency components corresponding to the generated scrambled data are diffused.

Also, in the transmission system according to the embodiment, when all pieces of data used as the initial value are “0”, a PN pattern is generated using data having all bits of “1”, and thus it is possible to avoid a situation that both the quotient and the remainder obtained by division with a generator polynomial are “0”.

Also, in the transmission system according to the first embodiment, since data included in the 1st byte of D code of the user data to be transmitted serves as the initial value, it is possible to achieve a circuit having a low probability of exhibiting periodicity in a relatively simple circuit configuration.

<Modification of Transmission System According to Embodiment>

Although a PN pattern is generated using the generator polynomial of PN7 in the transmission systems 1 and 2, a PN pattern may be generated using another polynomial such as PN15 in the transmission system according to the embodiment.

Although the signal value storage circuit 44 stores 7 bits of “1” in the transmission systems 1 and 2, the signal value storage circuit may store predetermined data having at least one nonzero bit in the transmission system according to the embodiment.

Although an example in which a signal is transmitted from the transmission device to the reception device has been presented in the transmission systems 1 and 2, a signal may be transmitted between transmission apparatuses each of which has both the transmission device and the reception device in the transmission system according to the embodiment.

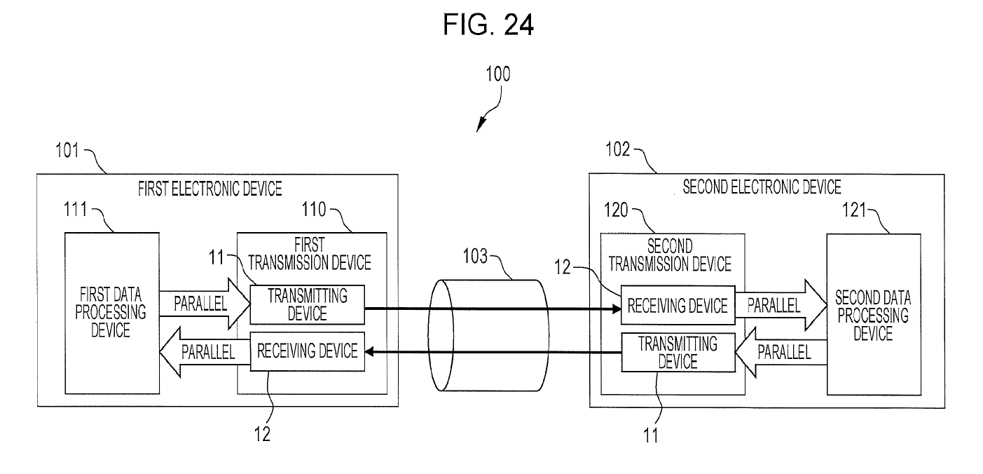

FIG. 24 is a diagram illustrating a transmission system according to a third embodiment.

The transmission system has a first electronic device 101, a second electronic device 102, and an optical fiber 103 that is a transmission path disposed between the first electronic device 101 and the second electronic device 102. The first electronic device 101 has a first transmission device 110 and a first data processing device 111, and the second electronic device 102 has a second transmission device 120 and a second data processing device 121. Both the first transmission device 110 and the second transmission device 120 have the transmission device 11 and the reception device 12. Since the configuration and function of the transmission device 11 and the reception device 12 have been described with reference to FIG. 6, a detailed description is omitted here. In the first electronic device 101, the transmission device 11 generates a transmission signal from the user data outputted from the first data processing device 111, and transmits the generated transmission signal to the second electronic device 102 via the optical fiber 103. In the second electronic device 102, the reception device 12 restores the user data from a reception signal, and outputs the restored user data to the second data processing device 121. Also, in the second electronic device 102, the transmission device 11 generates a transmission signal from the user data outputted from the second data processing device 121, and transmits the generated transmission signal to the first electronic device 101 via the optical fiber 103. In the first electronic device 101, the reception device 12 restores the user data from a reception signal, and outputs the restored user data to the first data processing device 111.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission circuit comprising:
a transmission-side generation circuit configured to extract data at a predetermined byte position from user data to be transmitted, and to generate a transmission random pattern having a predetermined bit length by performing predetermined calculation processing using a value of the extracted data;
a calculation circuit configured to generate transmission byte scrambled data by performing calculation on each byte of the user data and the generated transmission random pattern;
a transmission-data coupling circuit configured to generate transmission scrambled data by coupling the generated transmission byte scrambled data and the data extracted by the transmission-side generation circuit; and
a data-generation circuit configured to generate, from the transmission scrambled data, transmission data to be transmitted from the transmission circuit.

2. The transmission circuit according to claim 1, further comprising
a reception circuit configured to receive reception data,
wherein the reception circuit includes:
a generation circuit configured to generate reception scrambled data from the reception data;
a data-extraction circuit configured to extract data at a predetermined byte position from the reception scrambled data;
a reception-side generation circuit configured to generate a reception random pattern having one byte length by performing the calculation processing using a value of the data extracted by the data-extraction circuit;
an inverse operation circuit configured to generate inverse diffusion byte scrambled data by performing calculation on each byte of the reception data and the generated reception random pattern; and
a reception-data coupling circuit configured to restore the user data by coupling the generated inverse diffusion byte scrambled data and the data extracted by the data-extraction circuit.

3. The transmission circuit according to claim 2,
wherein the transmission-side generation circuit includes:
a transmission-side zero-determination circuit configured to determine whether all bits in data used as the value, in the extracted data are “0”;
a transmission-side signal value storage circuit configured to store predetermined data in which at least one bit is not “0”; and
a transmission-side selection circuit configured to, when it is determined by the transmission-side zero-determination circuit that the data used as the value are all “0”, output the data stored by the transmission-side signal value storage circuit to the transmission-side generation circuit as the value, and
the data-extraction circuit includes:
a reception-side zero-determination circuit configured to determine whether all bits in data used as the value, in the extracted data are “0”;
a reception-side signal value storage circuit configured to store predetermined data in which at least one bit is not “0”; and
a reception-side selection circuit configured to, when it is determined by the reception-side zero-determination circuit that the data used as the value are all “0”, output the data stored by the reception-side signal value storage circuit to the transmission-side generation circuit as the value.

4. The transmission circuit according to claim 2,
wherein each of the transmission-side generation circuit and the data-extraction circuit extracts a first byte of data.

5. The transmission circuit according to claim 2,
wherein each of the transmission-side generation circuit and the data-extraction circuit extracts data at a predetermined byte position,
the calculation circuit generates transmission byte scrambled data by performing calculation on data other than the data at a predetermined byte position of the user data and the transmission random pattern,
the transmission-data coupling circuit couples the data extracted by the transmission-side generation circuit to the predetermined byte position of the transmission byte scrambled data,
the inverse operation circuit generates inverse diffusion byte scrambled data by performing calculation on data other than the data at the predetermined byte position of the user data and the reception random pattern, and
the reception-data coupling circuit couples the data extracted by the data-extraction circuit to the predetermined byte position of the inverse diffusion byte scrambled data.

6. The transmission circuit according to claim 1,
wherein the value of the extracted data is an initial value determined from the extracted data.

7. The transmission circuit according to claim 2,
wherein the value of the data extracted by the data-extraction circuit is an initial value determined from the data extracted by the data extraction circuit.

8. A transmission apparatus comprising:
a transmission device including a transmission circuit configured to generate transmission data from user data, and a transmission signal generation circuit configured to generate a transmission signal from the transmission data and to transmit the transmission signal; and
a reception device including a reception-data generation circuit configured to receive a reception signal and to generate reception data from the reception signal, and a reception circuit configured to restore the user data from the reception data,
wherein the transmission circuit includes:
an extraction circuit configured to extract data at a predetermined byte position from user data to be transmitted;
a transmission-side generation circuit configured to generate a transmission random pattern having a predetermined bit length by performing predetermined calculation processing using a value of the data extracted by the extraction circuit;
a calculation circuit configured to generate transmission byte scrambled data by performing calculation on each byte of the user data and the generated transmission random pattern;
a transmission-data coupling circuit configured to generate transmission scrambled data by coupling the generated transmission byte scrambled data and the data extracted by the extraction circuit; and
a data-generation circuit configured to generate the transmission data from the transmission scrambled data,
the reception circuit includes:
a generation circuit configured to generate reception scrambled data from the reception data;
a data-extraction circuit configured to extract data at a predetermined byte position from the reception scrambled data;
a reception-side generation circuit configured to generate a reception random pattern having one byte length by performing the calculation processing using a value of the data extracted by the data-extraction circuit;
an inverse operation circuit configured to generate inverse diffusion byte scrambled data by performing calculation on each byte of the reception data and the generated reception random pattern; and
a reception-data coupling circuit configured to restore the user data by coupling the generated inverse diffusion byte scrambled data and the data extracted by the extraction circuit.

9. A method of transmitting data between a transmission circuit configured to transmit transmission data and a reception circuit configured to receive the transmission data as reception data via a transmission path, the method comprising:
causing the transmission circuit to:
extract data at a predetermined byte position from user data to be transmitted,
generate a transmission random pattern having a predetermined bit length by performing predetermined calculation processing using a value of the extracted data,
generate transmission byte scrambled data by performing calculation on each byte of the user data and the generated transmission random pattern,
generate transmission scrambled data by coupling the generated transmission byte scrambled data and the extracted data, and generate the transmission data from the transmission scrambled data; and
causing the reception circuit to:
generate reception scrambled data from the reception data,
extract data at a predetermined byte position from the reception scrambled data,
generate a reception random pattern having one byte length by performing the calculation processing using a value of the extracted data,
generate inverse diffusion byte scrambled data by performing calculation on each byte of the reception data and the generated reception random pattern, and
restore the user data by coupling the generated inverse diffusion byte scrambled data and the extracted data.
